(19) United States
(12) Patent Application Publication
(10) Pub. No.: US 2017/0309035 A1
(43) Pub. Date: Oct. 26, 2017

(54) MEASUREMENT APPARATUS, MEASUREMENT METHOD, AND ARTICLE MANUFACTURING METHOD AND SYSTEM

(71) Applicant: CANON KABUSHIKI KAISHA, Tokyo (JP)

(72) Inventor: Yusuke Koda, Utsunomiya-shi (JP)

(21) Appl. No.: 15/492,023

(22) Filed: Apr. 20, 2017

(30) Foreign Application Priority Data
Apr. 25, 2016 (JP) 2016-087120

(51) Int. Cl. G06T 7/529; G06T 5/50; G06T 7/73; G06T 7/00; G06T 7/586; G06T 7/13; H04N 5/225; G06T 7/521

(52) U.S. Cl. CPC G06T 7/529; H04N 5/2256; G06T 5/50; G06T 7/521; G06T 7/0004; G06T 7/586; G06T 7/13; G06T 7/75; G06T 2207/10004; G06T 2207/30164

(57) ABSTRACT

Provided is a measurement apparatus which includes: an illuminating unit for grayscale image configured to illuminate an object by two light sources among a plurality of light sources specified based on a periodic direction of streaks on a surface of the object and arranged opposite to each other with respect to an optical axis of the illumination unit for distance image and a processing unit configured to correct a pattern projection image based on the grayscale image obtained by imaging the object illuminated by the two light sources.

### BACKGROUND OF THE INVENTION

### Field of the Invention

The present disclosure relates to a measurement apparatus, a measurement method, and an article manufacturing method and a system.

### Description of the Related Art

One of the techniques for evaluating the shape of a surface of an object includes an optical three-dimensional information measurement apparatus. Additionally, one of the methods for optically measuring the three-dimensional information includes a method called a “pattern projection method”. This method is to measure the three-dimensional information about an object by projecting a predetermined projection pattern onto the object to be measured, capturing an image of the object having the predetermined pattern projected thereon to obtain a captured image, and calculating distance information in each pixel position according to the principle of triangulation. In the pattern projection method, pattern coordinates are detected based on spatial distribution information about an amount of light reception obtained from the captured image. However, the spatial distribution information about the amount of light reception is data that includes influence from unevenness of brightness (light intensity) due to a reflectance distribution by the pattern on the surface of the object to be measured and the like, and a reflectance distribution by the minute shape on the surface of the object to be measured and the like. These reflectance distributions may cause a large error in the information about the pattern detection, or make the detection itself impossible. As a result, the measured three-dimensional information has low precision. In contrast, in Japanese Patent Laid-Open No. 1991-289505, an image in irradiating uniform illumination light (hereinafter referred to as a “grayscale image”) is acquired at a timing different from one at which an image in projecting a pattern light (hereinafter, referred to as a “pattern projection image”) is acquired. By using the data of the grayscale image as data for correction, dispersion of the reflectance distribution on the surface of the object to be measured can be removed from the pattern projection image.

However, in Japanese Patent Laid-Open No. 1991-289505, the pattern projection image and the grayscale image are imaged by the light emitted from the same light source, and a liquid crystal shutter switches between using and not using a pattern at the time of obtaining the two images. For this reason, the two images are not obtained at the same time. In measurement by a position and posture measurement apparatus, the distance information may be acquired while either the object to be measured or the measurement apparatus is moved. In this case, since the relative positional relationship therebetween is not stable and thereby the image is captured at a viewpoint that is different from those of the pattern projection image and the grayscale image, the pattern projection image cannot be corrected with high precision.

### SUMMARY OF THE INVENTION

A measurement apparatus for measuring a position and a posture of an object according to one aspect of the present disclosure, comprising: a projecting unit which projects a pattern light to the object; an illuminating unit which illuminates the object by a plurality of light sources; an imaging unit which images the object onto which the pattern light is projected and images the object illuminated by the plurality of light sources; and a processing unit that obtains distance information about the object based on a pattern projection image obtained by imaging the object onto which the pattern light is projected, and a grayscale image obtained by imaging the object illuminated by the plurality of light sources. The illuminating unit illuminates the object by two light sources among the plurality of light sources specified based on a periodic direction of streaks on the surface of the object and arranged opposite to each other with respect to the optical axis of the projecting unit. The processing unit corrects the pattern projection image based on the grayscale image obtained by imaging the object illuminated by the two light sources.

Further features of the present disclosure will become apparent from the following description of exemplary embodiments with reference to the attached drawings.

### BRIEF DESCRIPTION OF THE DRAWINGS

FIG. 1 illustrates a configuration of a measurement apparatus.

FIG. 2 illustrates a projection pattern according to a first embodiment.

FIG. 3 illustrates an illumination unit for grayscale image according to the first embodiment.

FIG. 4 illustrates a grayscale image on an object.

FIG. 5A illustrates a configuration when a dipole direction of light sources included in the measurement apparatus according to the first embodiment is parallel to a periodic direction of a brightness distribution.

FIG. 5B illustrates a configuration when the dipole direction of the light sources included in the measurement apparatus according to the first embodiment is perpendicular to the periodic direction of the brightness distribution.

FIG. 6 illustrates a relationship between an angle of a surface to be measured and the reflectance.

FIG. 7A illustrates a pattern projection image on the object to be measured.

FIG. 7B illustrates a gray scale image when the object to be measured is illuminated by the light sources in FIG. 5A.

FIG. 7C illustrates a gray scale image when the object to be measured is illuminated by the light sources in FIG. 5B.

FIG. 8 is a measurement flow according to the first embodiment.

FIG. 9 is a measurement flow according to a second embodiment.

FIG. 10A illustrates a brightness distribution of the gray scale image in FIG. 4.

FIG. 10B illustrates the periodic direction of the brightness distribution.

FIG. 11 illustrates a configuration of a control system.

### DESCRIPTION OF THE EMBODIMENTS

### First Embodiment

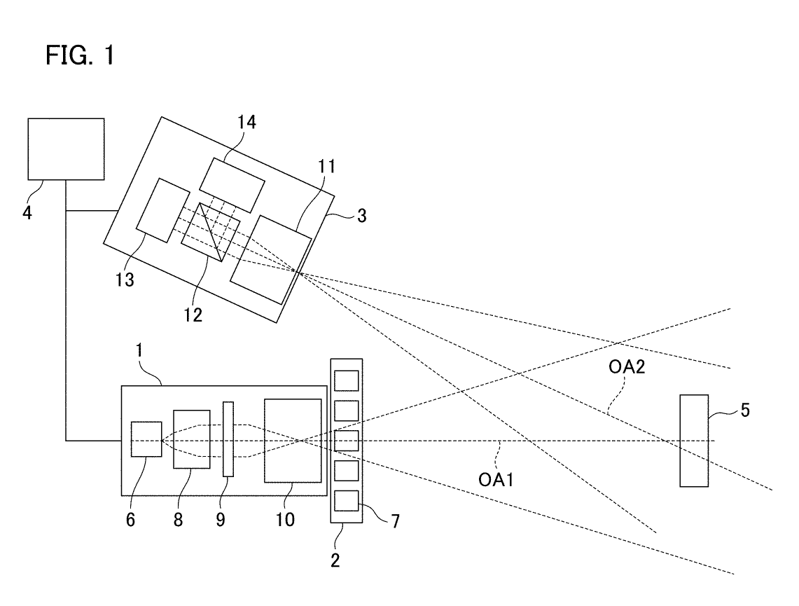

FIG. 1 is a general view of a position and posture measurement apparatus. As shown in FIG. 1, the position and posture measurement apparatus includes an illumination unit for distance image 1, an illumination unit for grayscale image 2, an imaging unit 3, and a calculation processing unit 4. The position and posture measurement apparatus images a distance image and a grayscale image at the same time and then, measures a position and a posture of an object 5 by model fitting by simultaneously using the two images. Note that the model fitting is performed with respect to a CAD model of the object to be measured 5 created in advance, and it is assumed that the three-dimensional shape of the object to be measured 5 is known. Also, the illumination unit for distance image 1 and the imaging unit 3 are integrated and mounted on a housing. The housing is provided in a robotic arm or the like.

Hereinafter, a description will be given of summaries of a distance image measuring unit for acquiring the distance image and a grayscale image measuring unit for acquiring the grayscale image respectively. First, a description will be given of the distance image measuring unit. The distance image represents three-dimensional information of points on the surface of the object to be measured, and each pixel thereof has depth information. The distance image measuring unit comprises the illumination unit for the distance image 1, the imaging unit 3, and the calculation processing unit 4. By the imaging unit 3, the distance image measuring unit captures a pattern light projected from the illumination unit for distance image 1, which is a projection unit for a pattern, to the object to be measured 5, from a direction that is different from that of the illumination unit for distance image 1 so as to acquire the captured image (pattern projection image). Additionally, from the pattern projection image, the calculation processing unit 4 calculates the distance image (distance information) based on the principle of triangulation.

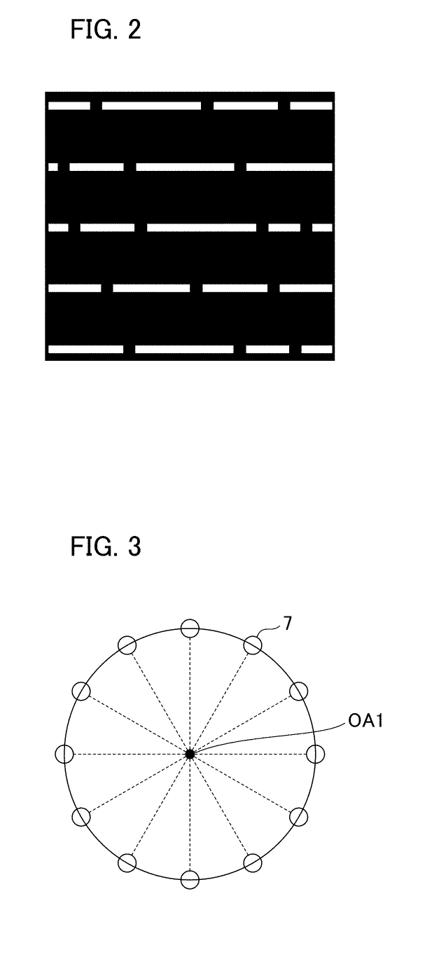

In this context, a description will be given of a pattern light projected from the illumination unit for the distance image 1 that is the projection unit for the pattern to the object to be measured 5. In the present embodiment, it is assumed that the position and the posture of the object to be measured is measured while a robot is moved. Therefore, in a measurement method for calculating the distance image from a plurality of captured images, a field shift of each captured image occurs due to the movement of the robot, which disables the high precision calculation of the distance image. Therefore, preferably, the pattern light projected from the illumination unit for distance image 1 to the object to be measured 5 is a pattern light by which the distance image can be calculated from one pattern projection image. The pattern light by which the distance image can be calculated from the one pattern projection image is disclosed, for example, in Japanese Patent NO. 2517062. In Japanese Patent NO. 2517062, the distance image is calculated from the one captured image by projecting a dot line pattern encoded by a dot as shown in FIG. 2 onto the object to be measured and corresponds the projection pattern with the captured image based on the positional relationship of the dot. Although the dot line pattern is described above as the specific projection pattern suitable for the present embodiment, the projection pattern according to the present embodiment is not limited thereto. Therefore, the projection pattern may be a pattern as long as it can calculate the distance image from the one pattern projection image.

The illumination unit for distance image 1 includes a light source 6, an illumination optical system 8, a mask 9, and a projection optical system 10. The light source 6 emits light with a different wavelength from that of a light source 7 in the illumination unit for grayscale image 2. According to the present embodiment, the wavelength of the light from the light source 6 is set as λ1, and that from the light source 7 is set as λ2. The illumination optical system 8 is an optical system for uniformly irradiating the light flux that exits from the light source 6 to the mask 9. In the mask 9, there is a drawn pattern projected onto the object to be measured 5. For example, chrome plating is applied to a glass substrate to form a desirable pattern. An exemplary pattern drawn in the mask 9 is the dot line pattern in FIG. 2 as described above. The projection optical system 10 is an optical system for forming a pattern image drawn in the mask 9 on the object to be measured 5. As described above, the illumination unit for distance image 1 uniformly irradiates the light flux that exits from the light source 6 onto the mask 9 by the illumination optical system 8, and forms the pattern image drawn in the mask 9 on the object to be measured 5 by the projection optical system 10. According to the present embodiment, a description is given of a method for projecting the pattern light with the fixed mask pattern. However, the present embodiment is not limited thereto, and the pattern light may be projected by using a DLP projector or a liquid crystal projector.

The imaging unit 3 that is the imaging unit includes an imaging optical system 11, a wavelength division element 12, an image sensor 13, and an image sensor 14. Since the imaging unit 3 is a unit common to the measurement for the distance image and that for the grayscale image, the grayscale image measuring unit hereinafter is also described here. The imaging optical system 11 is an optical system for forming a pattern for the measurement of the distance image and the grayscale image on the image sensors 13 and 14. The wavelength division element 12 is an optical element for separating the light from the light source 6, whose wavelength is λ1, and the light form the light source 7, whose wavelength is λ2. The light from the light source 6 whose wavelength is λ1 is transmitted and received at the image sensor 13, and the light from the light source 7 whose wavelength is λ2 is reflected and received at the image sensor 14. The image sensor 13 and the image sensor 14 are respectively elements for imaging the pattern projection image and the grayscale image. For example, each of the sensors may be a CMOS sensor or a CCD sensor or the like.

Next, a description will be given of the grayscale image measuring unit. The gray scale image is an image obtained by imaging a uniformly illuminated object. According to the present embodiment, an edge equivalent to a contour or a ridge of the object from the grayscale image is detected. The detected edge is used as an image feature amount in calculating the position and the posture. The grayscale image measuring unit includes the illumination unit for grayscale image 2, the imaging unit 3, and the calculation processing unit 4. The object to be measured 5 uniformly illuminated by the illumination unit for grayscale image 2 that is the illuminating unit is imaged by using the imaging unit 3 to acquire the captured image. Additionally, in the calculation processing unit 4, the edge is calculated from the captured image by edge detection processing. The illumination unit for grayscale image 2 that is the illuminating unit has a plurality of light sources 7. As shown in FIG. 3, the plurality of light sources 7 is arranged in a ring around the exit optical axis OA1 of the projection optical system 10 in the illumination unit for distance image 1. FIG. 3 is a diagram in which the illumination unit for grayscale image 2 is seen from the direction of the optical axis OA1 of the projection optical system.

The calculation processing unit 4 that has acquired the pattern projection image and the grayscale image performs the correction for a brightness (light intensity) distribution with respect to the pattern projection image (correction for the distribution of the amount of light reception). The correction for the distribution of the amount of light reception is performed by a correction processing unit (processing unit) in the calculation processing unit 4, by using the pattern projection image I₁(x,y) and the grayscale image I₂(x,y). The pattern projection image I₁′(x,y) in which the distribution of the amount of light reception is corrected, is calculated based on the following formula (1):

[formula 1]

I′₁(x,y)=I₁(x,y)/I₂(x,y) (1)

wherein x and y designate pixel coordinate values for a camera.

According to the present embodiment, although the correction by division is performed according to the formula (1), the correcting method of the present embodiment is not limited to division. The correction by subtraction may also be performed.

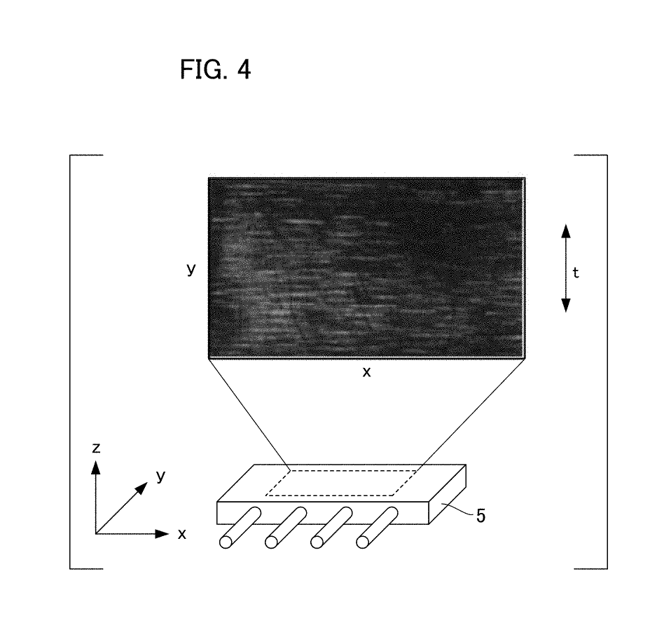

Here, a description will be given of the correction for the distribution of the amount of light reception when the surface of the object to be measured 5 has anisotropic characteristics. FIG. 4 illustrates an exemplary grayscale image of the object to be measured 5 with a minute streak-like shapes on its surface. A number of the streaks extended in x direction is periodically formed in y direction on the surface of the object to be measured 5. FIG. 4 is a grayscale image in which the part of the dashed line on the surface of the object to be measured 5 is imaged. In the image, the distribution of the amount of light reception for the streak-like shape resulting from the minute shape is generated. Here, a direction by which the distribution of the amount of light reception in the grayscale image as shown in FIG. 4 is more altered (y direction) is set as a periodic direction “t” of the brightness distribution. This minute streak-like shape is generated, for example, in the object to be measured made of resin by mold injection on which a grinding mark of a mold is transferred. The directions of the streaks on the surface of the object to be measured are always in the same direction if the method for processing the mold used in the manufacture or the like is not changed. Therefore, it can be assumed that there is no individual difference between similar types of the objects to be measured.

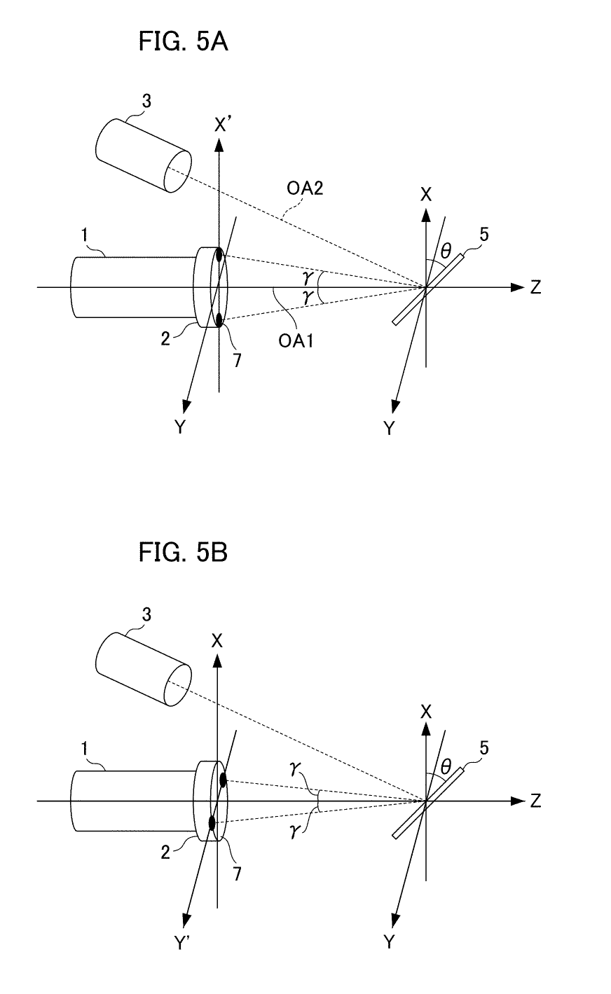

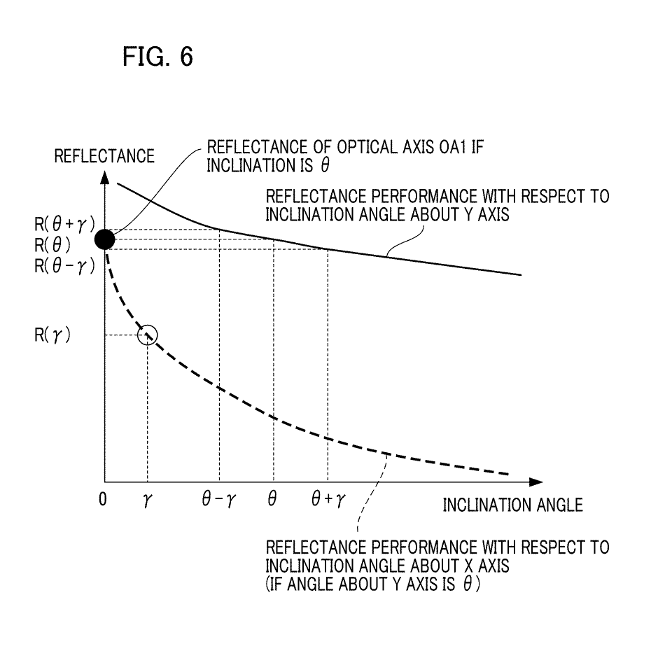

Such an object with the brightness distribution of the streak-like shape can obtain the higher effect for the correction if the distribution of the amount of light reception is corrected in the grayscale image obtained in a case that the specific two of the light sources 7 are illuminated, relative to the grayscale image obtained in a case that all of the light sources 7 are illuminated (ring illumination). A description will be given of a factor of the correction effect by the dipole illumination which allows a specific two of the light sources 7 to emit the light, with reference to FIG. 5A, FIG. 5B, and FIG. 6. FIG. 5A and FIG. 5B illustrate a relationship between a pair of the light sources 7 included in the illumination unit for grayscale image 2 and the exit optical axis OA 1 of the illumination unit for distance image 1. Here, a Z axis is a same axis as the exit optical axis OA 1, and an X-Y plane is a plane perpendicular to the Z axis. The object to be measured 5 is set to be arranged such that the periodic direction of the brightness distribution is toward an X axis, and to incline at θ about a Y axis. An angle between the line intersecting any one of the light sources 7 and the object to be measured 5 and the exit optical axis OA1 of the illumination unit for distance image 1 is set as γ. Also, the light sources 7 of the illumination unit for grayscale image 2 are arranged in a ring about the exit optical axis OA 1 of the projection optical system 10. Therefore, the dipole illumination in which the two of the light sources 7 of the illumination unit for grayscale image 2 is illuminated, sets the exit optical axis OA1 (Z axis) as an axis of symmetry.

FIG. 5A illustrates a configuration when the dipole direction of the dipole illumination by a pair of the light sources 7 (direction intersecting the two light sources) is an X′ direction, that is, parallel to the periodic direction of the brightness distribution. This dipole direction is also a direction perpendicular to the unevenness of the streaks. In contrast, FIG. 5B illustrates a configuration when the dipole direction of the dipole illumination (direction intersecting the two light sources) is a Y′ direction, that is, perpendicular to the periodic direction of the brightness distribution. This dipole direction is also a direction parallel to the unevenness of the streaks.

FIG. 6 illustrates a relationship between an inclination angle θ and the reflectance R(θ) in the object to be measured, wherein a reflectance curve is drawn as a solid line if the object to be measured inclines about a Y axis, and the reflectance curve is drawn as a dashed line if the inclination angle about the Y axis is θ and the object to be measured inclines about an X axis, as shown in FIG. 5A and FIG. 5B. Note that the inclination angle of the object to be measured with respect to the pattern projection is θ. In the solid line, since the change in the reflectance with respect to the inclination angle is small and thus the range of the inclination angle from (θ−γ) to (θ+γ) can be considered to be linear, the following formula (2) is approximately established.

[formula 2]

R(θ)=(R(θ+γ)+R(θ−γ))/2 (2)

In other words, in the area in which the angle characteristic of the reflectance is approximately linear, the brightness distribution of the pattern projection image (R(θ)) is almost equal to the brightness distribution of the grayscale image (for example, when the inclination angle of the object to be measured to the dipole illumination is (θ+γ) and (θ−γ), then (R(θ+γ)+R(θ−γ))/2).

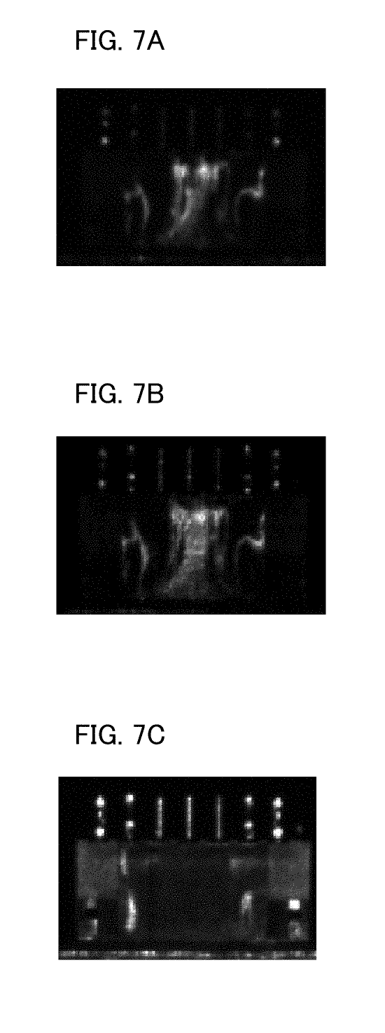

FIG. 7A illustrates the brightness distribution of the pattern projection image. In contrast, FIG. 7B and FIG. 7C illustrate the brightness distributions of the grayscale images. FIG. 7B is the grayscale image when the object to be measured 5 is illuminated by the dipole illumination as shown in FIG. 5A. FIG. 7C is the grayscale image when the object to be measured 5 is illuminated by the dipole illumination as shown in FIG. 5B. The brightness distribution of the pattern projection image as shown in FIG. 7A is almost equal to the bright distribution of the grayscale image as shown in FIG. 7B. FIG. 7B is the grayscale image when the dipole direction of the dipole illumination is the X′ direction, that is the same direction as the periodic direction of the brightness distribution. Therefore, correlation between the brightness distribution of the pattern projection image and the brightness distribution of the grayscale image can be improved by setting the direction of the dipole illumination (direction intersecting the two light sources) parallel to the periodic direction of the brightness distribution of the object to be measured. Therefore, the influence of the brightness distribution resulting from the shape of the surface of the object to be measured can be removed by correcting the distribution of the amount of light reception by the grayscale image.

In contrast, in a case of the dipole illumination in the Y′ direction as shown in FIG. 5B, the reflectance of the light incident with the exit optical axis OA1 of the illumination unit for distance image 1 is plotted as a black circle, and the reflectance of the light which inclines at the incident angle γ with respect to OA1 is plotted as a white circle in FIG. 6. If the object to be measured is arranged such that the periodic direction of the brightness distribution of the object to be measured is the X direction, the incident angle for the reflectance (black circle) of the illumination unit for distance image 1 differs only negligibly from that for the reflectance (white circle) of the dipole illumination, by γ. However, the reflectances thereof are significantly different from each other. The reason for this is that the reflectance characteristic is smooth with respect to the angle, since the reflectance light is generated in many of directions among directions perpendicular to the streaks (similar to the periodic direction of the brightness distribution) by the structure of the streaks in the object to be measured. In contrast, since there are fewer structures of the strike in the streak direction, the reflectance characteristic is steep with respect to the angle. Therefore, the brightness distribution of the pattern projection image as shown in FIG. 7A is significantly different from that of the grayscale image as shown in FIG. 7C. FIG. 7C is the gray scale image when the dipole direction of the dipole illumination (direction intersecting the two light sources) is the Y′ direction, that is perpendicular to the periodic direction of the brightness distribution. In the case of the ring illumination, the illumination is considered to be the dipole illumination in a variety of directions, and makes the image that is a combination of FIG. 7B and FIG. 7C. Therefore, the brightness distribution of the pattern projection image is different from that of the grayscale image, which disables obtaining the correction effect.

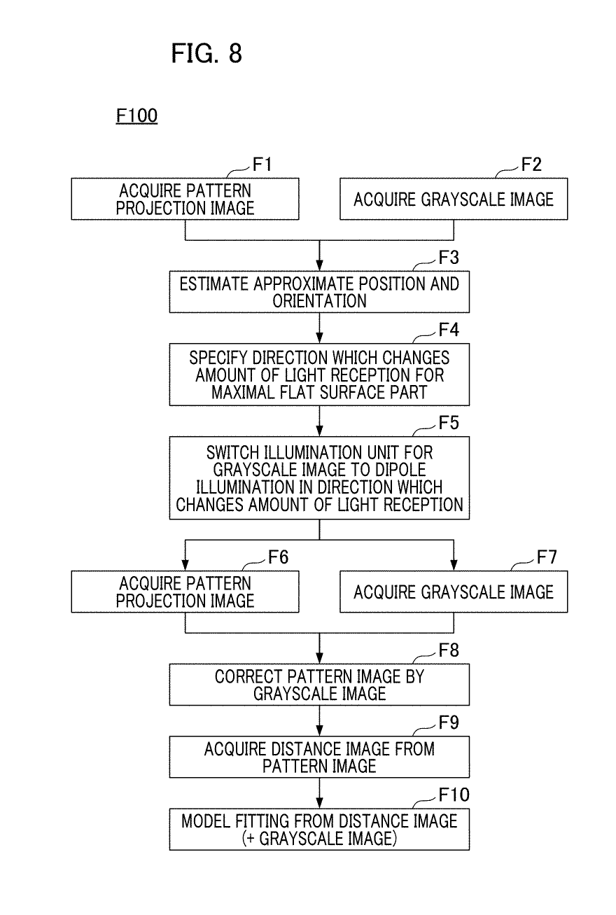

As described above, if the surface of the object to be measured is anisotropic, the dipole direction of the dipole illumination in the illumination unit for grayscale image 2 (direction intersecting the two light sources) is set parallel to the periodic direction of the brightness distribution of the object to be measured so as to significantly correlate the brightness distribution on the pattern projection image with the brightness distribution on the grayscale image. Thereby, the high correction effect can be obtained. Hereinafter, by using a flowchart in FIG. 8, a description will be given of a representative measurement flow when the surface of the object to be measured is anisotropic.

As described above, although the CAD model for the object to be measured has been already created and registered prior to the measurement, at this time, information about the periodic direction of the brightness distribution is together registered in each plane of the CAD model and the registered information is used to determine the dipole direction of the illumination for the gray scale image. The periodic direction of the brightness distribution is set so as to be previously registered with respect to each plane of the CAD model. FIG. 8 illustrates a measurement process F100 consisting of steps F1 to F10. In step F1 and step F2, the pattern projection image and the grayscale image are acquired. Next, in step F3, edge information detected from the distance image calculated based on the pattern projection image and the gray scale image is matched to the CAD model previously registered so as to acquire the approximate position and the posture of the object to be measured with respect to the apparatus. The approximate position and the posture can be acquired by using the method described in JP patent NO. 5393318 and the like.

Next, if two or more flat surfaces of a plurality of flat surfaces constituting the object to be measured imaged in the gray scale image (recognized from the grayscale image) have a periodic brightness distribution, the flat surface part set as the maximal area in the pattern projection image is specified in step F4. Additionally, the periodic direction of the brightness distribution in the flat surface part of the maximal area (direction which changes the amount of light reception) is determined based on the approximate position and posture acquired in step F3 and the periodic direction of the brightness distribution in each surface of the object to be measured previously registered. Here, instead of the approximate position and posture acquired in step F3, the distance image may be calculated from the pattern projection image in which the correction for the distribution of the amount of light reception is not performed by the grayscale image, since it is only necessary to obtain a precision sufficient to acquire the periodic direction of the brightness distribution at the maximal side part.

Next, in step F5, the two of a plurality of emission units in the illumination unit for grayscale image 2 emit light such that the dipole illumination is set in the direction that is the same as (parallel to) the periodic direction of the brightness distribution of the object to be measured acquired in step F4. Here, the two emission units arranged in opposite to each other with respect to the optical axis of the projecting unit are specified based on the periodic direction of the light intensity distribution on the surface of the object to be measured. Preferably, the two emission units are symmetrically arranged with respect to the optical axis of the projecting unit. However, the units may not be strictly symmetrically arranged. Also, the number of the units is not limited two, and there may be three or more emission units. In step F6 and step F7, the pattern projection image and the grayscale image is re-acquired. Additionally, the correction for the distribution of the amount of light reception is performed in step F8. The correcting method is performed by dividing the pattern projection image by the grayscale image as described above. Since the high correction effect for the distribution of the amount of light reception is acquired in step F8, a distance is calculated based on the obtained pattern image in step F9. Additionally, the position and the posture of the object to be measured are acquired by performing the model fitting in step F10.

According to the present embodiment described above, the correction for the distribution of the amount of light reception can be performed by the brightness distribution of the grayscale image which significantly correlates with the brightness distribution of the pattern projection image even if the object to be measured has anisotropic characteristics. Therefore, the position and the posture of the object to be measured can be measured with high precision.

### Second Embodiment

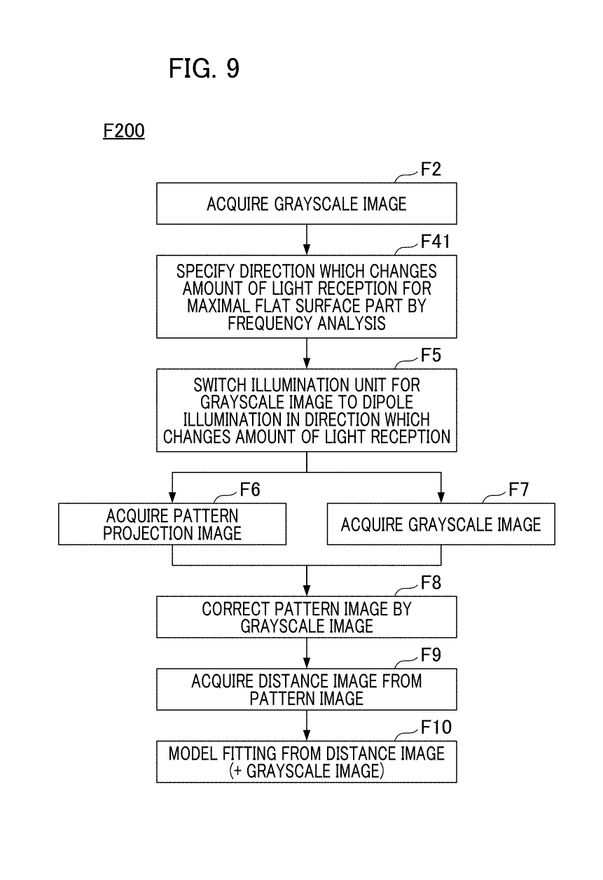

While in the first embodiment, the information about the periodic direction of the brightness distribution in each plane of the CAD model is registered prior to the measurement, in a second embodiment, a description will be given of a measurement process when the information about the periodic direction of the brightness distribution cannot be registered in advance in each plane of the CAD model. Although the second embodiment has a configuration for the apparatus that is the same as that in the first embodiment, it has the different measurement process from that of the first embodiment. Thus, this embodiment is described with respect to this point. FIG. 9 illustrates the representative measurement process F200 according to the present embodiment. The first point that is different from the first embodiment is that it is not necessary to acquire the pattern projection image in step F1 and estimate the approximate position and the posture in step F3. The second point that is different from the first embodiment is that a step F41, in which the periodic direction of the brightness distribution is acquired based on frequency analysis, is used instead of step F4, in which the periodic direction of the brightness distribution for the maximal area part are specified based on the approximate position and the posture.

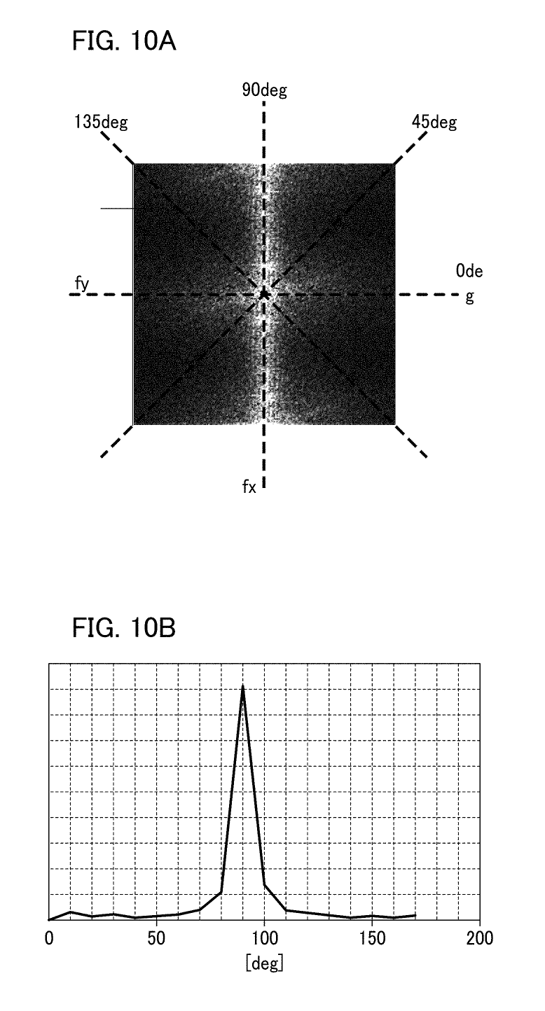

In step F41, the frequency analysis is performed with respect to the acquired distribution of the amount of light reception from the grayscale image obtained in step F2, and then a direction with larger change in the distribution of the amount of light reception, that is, the periodic direction of the brightness distribution, is specified. FIG. 10A and FIG. 10B illustrate examples in which the distribution of the amount of light reception is analyzed. FIG. 10A illustrates an intensity distribution for each frequency as a result of processing of two-dimensional FFT to the gray scale image in FIG. 4. The vertical axis fx and the horizontal axis fy respectively represent the frequencies in an x direction and a y direction. The horizontal axis in FIG. 10B represents a posture direction when an x axis in FIG. 10A is set as 0°, and values summed for intensity in each posture direction are plotted in the vertical axis. Here, while the posture direction sums the value with a range of ±5 degree with respect to each posture, the present embodiment is not limited thereto. As can be seen from FIG. 10B, the peak is in the 90° posture direction and therefore, it is understood that the periodic direction of the brightness distribution resulting from work has a strong change in the amount of the light reception in the y axis direction. As just described, in step F41, the periodic direction of the brightness distribution can be acquired based on the frequency analysis. Accordingly, it is not necessary to register the periodic direction of the brightness distribution prior to the measurement, since the periodic direction of the brightness distribution is acquired only from the grayscale image.

The following steps from F5 to step F10 are similar to those in the measurement process F100 in the first embodiment. As described above, according to the second embodiment, even when the object to be measured has anisotropic characteristics, the correction for the distribution of the amount of light reception can be performed by the grayscale image which significantly correlates with the pattern projection image. Therefore, the position and the posture of the object to be measured can be measured with high precision.

### Third Embodiment

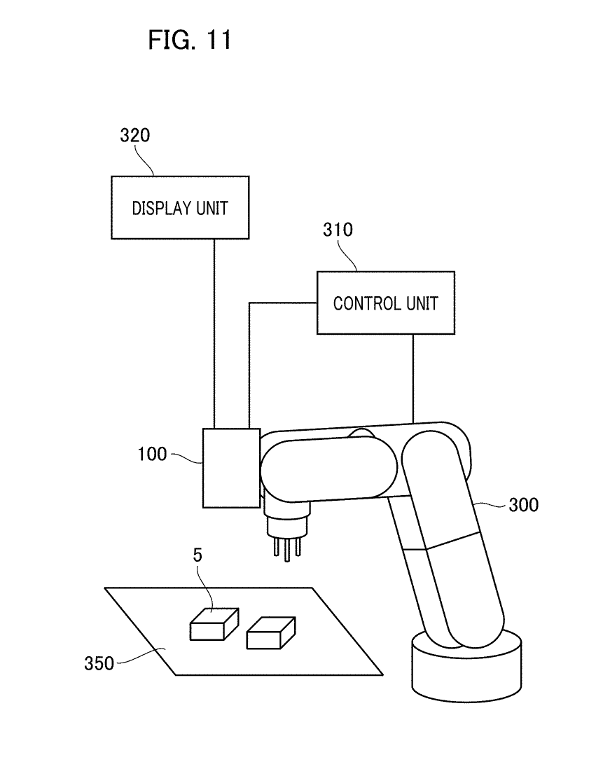

Anyone of the above-described measurement apparatuses can be used while being supported by a given support member. In this embodiment, a control system that is attached to a robotic arm 300 (gripping apparatus) and used, as shown in FIG. 11, will be described as an example. A measurement apparatus 100 images an object 5 placed on a support table 350 by projecting a pattern light on the object to be measured 5, thereby acquiring an image. A control unit of the measurement apparatus 100 or a control unit 310 that has acquired image data from the control unit of the measurement apparatus 100 obtains the position and posture of the object to be measured 5, and the control unit 310 acquires information about the obtained position and posture. Based on the information about the position and posture of the object to be measured 5 as the result of the measurement, the control unit 310 controls the robotic arm 300 by sending a driving command to the robotic arm 300. The robotic arm 300 holds the object to be measured 5 by a robot hand or the like (gripping portion) at the distal end to perform movement such as translation and rotation. Furthermore, the robotic arm 300 can assemble the object to be measured 5 with other parts, thereby manufacturing an article formed from a plurality of parts, for example, an electronic circuit substrate or a machine. It is also possible to manufacture an article by processing the moved object to be measured 5. The control unit 310 includes a processing unit such as a CPU, and a storage device such as a memory. Note that a control unit for controlling the robot may be provided outside the control unit 310. Furthermore, measurement data measured by the measurement apparatus 100 and the obtained image may be displayed on a display unit 320 such as a display.

### Embodiment According to an Article Manufacturing Method

The measurement apparatus according to the embodiments described above is used in an article manufacturing method. The article manufacturing method includes a process of measuring an object using the measurement apparatus, and a process of processing the object on which measuring is performed in the process based on the measurement results. The processing includes, for example, at least one of machining, cutting, transporting, assembly, inspection, and sorting. The article manufacturing method of the embodiment is advantageous in at least one of performance, quality, productivity, and production costs of articles, compared to a conventional method.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-087120 filed on Apr. 25, 2016, which is hereby incorporated by reference herein in its entirety.

What is claimed is:

1. A measurement apparatus for measuring a position and a posture of an object, comprising:
a projecting unit configured to project a pattern light to the object;
an illuminating unit configured to illuminate the object by a plurality of light sources;
an imaging unit configured to image the object onto which the pattern light is projected and image the object illuminated by the plurality of light sources; and
a processing unit configured to obtain distance information about the object based on a pattern projection image obtained by imaging the object onto which the pattern light is projected, and a grayscale image obtained by imaging the object illuminated by the plurality of light sources,
wherein the illuminating unit illuminates the object by two light sources among the plurality of light sources specified based on a periodic direction of streaks on the surface of the object and arranged opposite to each other with respect to an optical axis of the projecting unit,
wherein the processing unit corrects the pattern projection image based on the grayscale image obtained by imaging the object illuminated by the two light sources.

2. The measurement apparatus according to claim 1, wherein the two light sources are symmetrically arranged with respect to the optical axis of the projecting unit.

3. The measurement apparatus according to claim 1, wherein the periodic direction of the surface of the object is specified based on the position and the posture of the object previously acquired and information about the periodic direction of the streaks in each surface of the object.

4. The measurement apparatus according to claim 1, wherein the periodic direction of the streaks on the surface of the object is specified based on the grayscale image of the object.

5. The measurement apparatus according to claim 1, wherein the surface having the periodic direction is specified based on an area among a plurality of surfaces of the object recognized from the pattern projection image or the grayscale image.

6. A measurement method for measuring a position and a posture of an object, comprising steps of:
specifying a periodic direction of streaks on a surface of the object;
projecting a pattern light to the object and imaging the object onto which the pattern light is projected;
illuminating the object by two light sources specified based on a periodic direction of the streaks on the surface of the object and arranged opposite to each other with respect to an optical axis of a projecting unit which projects the pattern light, and imaging the object illuminated by the two light sources;
correcting a pattern projection image obtained by imaging the object onto which the pattern light is projected, based on a grayscale image obtained by imaging the object illuminated by the two light sources;
calculating distance information about the object based on the corrected pattern projection image; and
acquiring the position and the posture of the object based on the distance information.

7. A system comprising:
the measurement apparatus according to claim 1; and
a robot which holds and moves the object based on a measurement result by the measurement apparatus.

8. A method for manufacturing an article, the method comprising steps of:
measuring a position and a posture of an object by using a measurement apparatus; and
manufacturing the article by processing the object based on the result of the measurement;
wherein the measurement apparatus comprises:
a projecting unit configured to project a pattern light to the object;
an illuminating unit configured to illuminate the object by a plurality of light sources;
an imaging unit configured to image the object onto which the pattern light is projected and image the object illuminated by the plurality of light sources; and
a processing unit configured to obtain distance information about the object based on a pattern projection image obtained by imaging the object onto which the pattern light is projected and a grayscale image obtained by imaging the object illuminated by the plurality of light sources,
wherein the illuminating unit illuminates the object by two light sources of the plurality of light sources specified based on a periodic direction of streaks on the surface of the object and arranged opposite to each other with respect to an optical axis of the projecting unit,
wherein the processing unit corrects the pattern projection image based on the grayscale image obtained by imaging the object illuminated by the two light sources.
